(19) United States
(12) Patent Application Publication
(10) Pub. No.: US 2020/0150858 A1
(43) Pub. Date: May 14, 2020

(54) CONTROLLING VEHICLE FUNCTIONS

(71) Applicant: Ford Global Technologies, LLC, Dearborn, MI (US)

(72) Inventors: Rodrigo LUNA GARCIA, Mexico City (MX); Diana Lucia VELASQUEZ, Mexico City, Df (MX)

(21) Appl. No.: 16/495,242

(22) PCT Filed: Mar. 21, 2017
(86) PCT No.: PCT/US2017/023346

§ 371 Date: Sep. 18, 2019

(51) Int. Cl. G06F 3/0488; G06F 3/041; B60K 35/00

(52) U.S. Cl. CPC G06F 3/04883; B60K 2370/1472; B60K 35/00; G06F 3/041

(57) ABSTRACT

A computer that includes a processor and memory, wherein the processor is programmed to execute instructions stored in the memory. Instructions may include: receive tactile data via a touch-sensitive user interface in a vehicle; using the data, identify a previously-configured symbol primitive that is associated with controlling a vehicle function; and provide an instruction to control the function based on the identification.

### BACKGROUND

Modern vehicles utilize a number of control features, including push-, pull-, or slider-buttons, dials, knobs, etc. to control vehicle functions and accessories. In addition, some vehicles further incorporate automatic speech recognition (ASR) techniques and voice control commands to operate at least some functions or accessories. As these types of interfaces become more complex, driver distraction may increase correspondingly—e.g., as some drivers may attempt to operate these increasingly available control features while operating the vehicle.

### SUMMARY

According to one example, a computer is described that may be programmed to: in a configuration mode associated with a touch-sensitive user interface in a vehicle: receive, via the interface, a symbol primitive, and receive an indication of at least one vehicle function to be associated therewith; and in an operational mode: receive, via the interface, tactile data, identify the primitive using the tactile data, and provide an instruction to perform the at least one vehicle function based on the identification.

According to an example, the tactile data may include at least one of: a plurality of contacted regions, an initial contact point, a terminal contact point, a vector associated with at least some of the plurality of contacted regions, or a time interval.

According to an example, the identification further may include comparing a tactile data set associated with the symbol primitive to the tactile data received during the operational mode.

According to an example, a screen of the interface may include a resistive-touch screen, a surface capacitive-touch screen, a projected capacitive-touch screen, a surface acoustic wave or SAW-touch screen, or an infrared-touch screen.

According to an example, the primitive and the tactile data may each be associated with a physical user contact and a user movement at a screen of the interface.

According to another example, a computer is described that is programmed to: receive tactile data via a touch-sensitive user interface in a vehicle; using the data, identify a previously-configured symbol primitive that is associated with controlling a vehicle function; and provide an instruction to control the function based on the identification.

According to an example, the data may include at least one of: a plurality of contacted regions, an initial contact point, a terminal contact point, a vector associated with at least some of the plurality of contacted regions, or a time interval.

According to an example, identifying further may include comparing the tactile data with other tactile data previously associated with the primitive that is stored in computer memory.

According to an example, the computer further may be programmed to receive the other tactile data during a user-initiated configuration mode.

According to an example, a screen of the interface comprises a resistive-touch screen, a surface capacitive-touch screen, a projected capacitive-touch screen, a surface acoustic wave or SAW-touch screen, or an infrared-touch screen.

According to an example, the computer further may be programmed to, prior to receiving the tactile data: receive a vehicle function control selection from a vehicle user; receive the primitive via the interface; and associate, in memory, the selection with the primitive.

According to an example, the primitive and the data may each be associated with contact of one or more vehicle user fingers relative to a touch-sensitive screen in the interface, movement of the one or more fingers relative to the screen, or both.

According to another example, a method is described that includes: receiving tactile data via a touch-sensitive user interface in a vehicle; using the data, identifying a previously-configured symbol primitive that is associated with controlling a vehicle function; and providing an instruction to control the function based on the identification.

According to an example of the method, the data may include at least one of: a plurality of contacted regions, an initial contact point, a terminal contact point, a vector associated with at least some of the plurality of contacted regions, or a time interval.

According to an example of the method, the identifying further may include comparing the tactile data with other tactile data previously associated with the primitive that is stored in computer memory.

According to an example of the method, the receiving may further include receiving the other tactile data during a user-initiated configuration mode.

According to an example of the method, a screen of the interface comprises a resistive-touch screen, a surface capacitive-touch screen, a projected capacitive-touch screen, a surface acoustic wave or SAW-touch screen, or an infrared-touch screen.

According to an example of the method, the method also may include, prior to receiving the tactile data: receiving a vehicle function control selection from a vehicle user; receiving the primitive via the interface; and associating, in memory, the selection with the primitive.

According to an example of the method, the primitive and the data are each associated with contact of one or more vehicle user fingers relative to a touch-sensitive screen in the interface, movement of the one or more fingers relative to the screen, or both.

According to an example of the method, the tactile data includes a plurality of first parameters and the primitive includes a plurality of second parameters, wherein the identifying includes determining a threshold level of similarity between the pluralities of first and second parameters.

Any of the computer programming instructions described above and herein may be carried out as a method or process. Similarly, any methods or processes described above and herein may be carried out as instructions executable by a computing device such as a vehicle computer. Further, any of the examples described above may be used in any suitable combination with one another.

### BRIEF DESCRIPTION OF THE DRAWINGS

FIG. 1 is a schematic view of a vehicle that includes a customizable vehicle function control system.

FIG. 2 is a perspective view of a vehicle interior illustrating an exemplary touch-sensitive user interface.

FIGS. 3-9 are schematic views of exemplary symbol primitives which may be used by a vehicle user to control one or more vehicle functions.

FIG. 10 is a schematic view of a tactile data set received via the user interface shown in FIG. 2 which corresponds to the symbol primitive shown in FIG. 4.

FIG. 11 is a schematic view of another tactile data set which at least partially corresponds to the data set shown in FIG. 10.

FIG. 12 is a schematic view of yet another tactile data set which may be determined to be confusingly similar with the data sets shown in FIGS. 10-11.

FIG. 13 is a flow diagram illustrating an exemplary process of using the vehicle function control system in a configuration mode.

FIG. 14 is a flow diagram illustrating an exemplary process of using the vehicle function control system in an operational mode.

### DETAILED DESCRIPTION

With reference to the figures, wherein like numerals indicate like parts throughout the several views, there is shown a customizable vehicle function control system 10 that permits a vehicle user to control one or more vehicle functions by drawing a symbol primitive on a touch-sensitive user interface 12 in a vehicle 14. The user interface 12 may be integrated into vehicle 14 (e.g., at time of manufacture or as an after-market component); and, as described more below, it may be part of a human-machine interface (HMI) 16—which is located in a floor console 18, in an instrument panel 20, in a center stack module 22, in a combination thereof (as shown in FIG. 1-2), or the like. As used herein, a symbol primitive is one or more previously user-determined symbols which, when drawn tactilely on the user interface 12 (e.g., with the user's finger), cause at least one vehicle function to be executed. The term symbol should be construed broadly to include one or more letters, numbers, characters, marks, the like, or combination thereof. The system 10 includes a programmable computer 24 which, in a configuration mode, can associate one or more vehicle functions with each user-determined symbol primitive—so that during an operational mode, when the user manually and tactilely enters the symbol primitive on the user interface 12, the computer 24 recognizes the symbol primitive and executes the associated vehicle function(s).

Referring to FIG. 1, the vehicle 14 is shown as a passenger car. However, for example, vehicle 14 instead could be a truck, sports utility vehicle (SUV), recreational vehicle, a bus or train (e.g., a school bus), marine vessel, aircraft, or the like that includes the customizable vehicle function control system 10. Although not required, vehicle 14 may be operated in any one of a number of autonomous modes. In at least one example, vehicle 14 may operate in a fully autonomous mode (e.g., a level 5), as defined by the Society of Automotive Engineers (SAE) (which has defined operation at levels 0-5). For example, at levels 0-2, a human driver monitors or controls the majority of the driving tasks, often with no help from the vehicle 14. For example, at level 0 (“no automation”), a human driver is responsible for all vehicle operations. At level 1 (“driver assistance”), the vehicle 14 sometimes assists with steering, acceleration, or braking, but the driver is still responsible for the vast majority of the vehicle control. At level 2 (“partial automation”), the vehicle 14 can control steering, acceleration, and braking under certain circumstances without human interaction. At levels 3-5, the vehicle 14 assumes more driving-related tasks. At level 3 (“conditional automation”), the vehicle 14 can handle steering, acceleration, and braking under certain circumstances, as well as monitoring of the driving environment. Level 3 may require the driver to intervene occasionally, however. At level 4 (“high automation”), the vehicle 14 can handle the same tasks as at level 3 but without relying on the driver to intervene in certain driving modes. At level 5 (“full automation”), the vehicle 14 can handle all tasks without any driver intervention.

As also shown in FIG. 1, vehicle 14 may include any suitable wired or wireless network connection 26 enabling communication between electronic devices such as HMI 16, computer 24, a powertrain control module 28, a climate control module 30, and a body control module 32, just to name a few non-limiting examples. In at least one example, the connection 26 includes one or more of a controller area network (CAN) bus, Ethernet, Local Interconnect Network (LIN), or the like. Other examples also exist. For example, alternatively or in combination with e.g., a CAN bus, connection 26 could comprise one or more discrete wired or wireless connections.

Human-machine interface (HMI) 16 may include any suitable input and/or output devices such as switches, knobs, controls, etc.—e.g., located on instrument panel 20, a vehicle steering wheel (not shown), etc. of an interior or cabin region 34 of vehicle 14 (FIGS. 1-2). These input/output devices may be coupled communicatively to, among other things, computer 24 and/or modules 28-32. Thus, HMI 16 enables the vehicle user to input data or receive output data (I/O) from the various computing devices onboard vehicle 14. HMI 16 may include one or more displays, as well as the interactive touch-sensitive user interface 12 discussed above.

User interface 12 may be fixed and/or integrated within the vehicle interior 34—e.g., in the floor console 18, in the instrument panel 20, within the center stack module 22, or the like. It may comprise a touch screen 36, one or more analog-to-digital converters (ADCs) 38, a digital signal processing (DSP) unit 40, as well as a microprocessor 42 and memory 44. In at least one example, touch screen 36 may be configured as both an input device and output device. As explained more below and among other things, screen 36 may receive symbol primitives as input—e.g., when the user physically contacts the screen 36 and draws a symbol; and screen 36 may provide output as well—e.g., providing instructions and feedback to the user during the configuration and operational modes, which also will be discussed more below. Non-limiting examples of screen 36 include a resistive-touch screen, a surface capacitive-touch screen, a projected capacitive-touch screen, a surface acoustic wave or SAW-touch screen, or an infrared-touch screen, all of which are known in the art. For purposes of illustration only, screen 36 will be described as a surface capacitive-touch screen having a plurality of layers—e.g., including a protective layer, substrate layers having so-called driving lines and sensing lines, as well as a liquid crystal display (LCD) layer which can project output data in the form of light through the protective and substrate layers.

Screen 36 may be coupled to the ADC 38, which may include any suitable electronic device or circuit that changes (or converts) analog signals to digital signals. ADCs, as well as their use and operation, also are generally known in the art and will not be described in great detail here. Thus, input data received via the touch screen 36 and ADC 38 may be digitized and received by the DSP unit 40.

DSP unit 40 may be a device which measures and interprets the data received from the ADC 38—e.g., using microprocessor 42 and memory 44. Among other things, the DSP unit 40 may determine tactile data (e.g., a tactile data set) from the ADC data that is representative of a symbol primitive. The data set may include a number of contacted positions on the screen 36, one or more vectors indicating directions in which the contact(s) were made by the user, as well as a time interval measuring vehicle user contact with the screen 36. The data set (representative of the symbol primitive) may be provided to the microprocessor 42, which in turn may transmit the data set to computer 24. Similarly, the microprocessor 42 may receive instructions from the computer 24 and cause various informational messages, vehicle function selections, etc. to be displayed on the screen 36 (e.g., by actuating the LCD layer or the like). And responses to such informational messages, vehicle function selections, etc. may be received via components 36-44 and provided to computer 24.

Computer 24 may be a single computer coupled to user interface 12 via connection 26 (as shown in FIG. 1). Or in other examples, computer 24 may comprise multiple computing devices—e.g., shared with other vehicle systems and/or subsystems. And in at least one example, user interface 12 and computer 24 are coupled within the same module—e.g., computer 24 may be located with user interface 12 in the floor console 18. Or in other examples, the computer 24 and user interface 12′ may be part of a common module located in the center stack module 22 or in the instrument panel 20. Of course, each of these are merely examples.

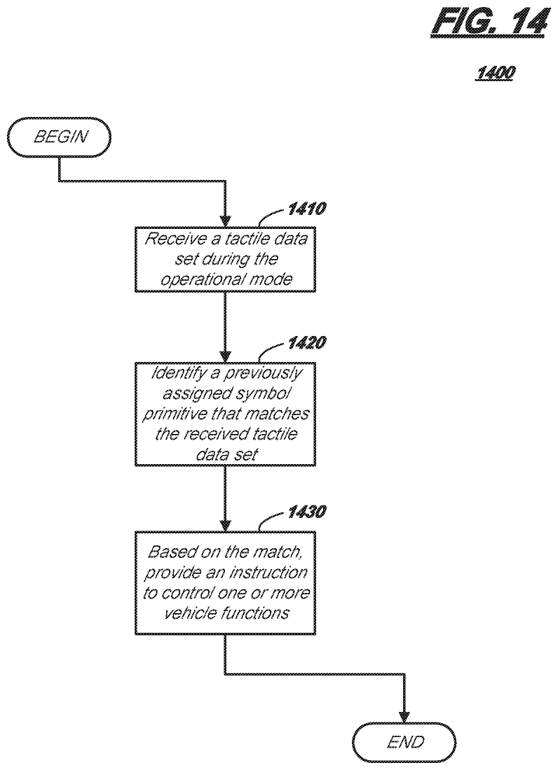

Computer 24 may comprise a number of components, including but not limited to a processor or processing circuit 52 coupled to memory 54. For example, processor 52 can be any type of device capable of processing electronic instructions, non-limiting examples including a microprocessor, a microcontroller or controller, an application specific integrated circuit (ASIC), etc.—just to name a few. In general, computer 24 may be programmed to execute digitally-stored instructions, which may be stored in memory 54, which enable the computer 24, among other things: to carry out a configuration mode for learning new symbol primitives provided by a vehicle user via user interface 12, to carry out an operational mode to cause vehicle functions to be executed when a symbol primitive is input tactilely via the user interface 12, to store a specific vehicle function (or identifier thereof) which is to be triggered in response to receiving a particular symbol primitive at the user interface 12, to store groupings of vehicle functions to be carried out collectively or concurrently (or identifiers thereof) which are to be triggered in response to receiving a particular symbol primitive at the user interface 12, to store in memory 54 one or more symbol primitives previously provided to computer 24, to associate each symbol primitive with one of the specific vehicle functions or with a grouping of vehicle functions, to add new symbol primitives to memory 54, to determine whether newly added symbol primitives are distinguishable from earlier stored primitives (e.g., in the configuration mode), to instruct a vehicle user to select a new symbol primitive at times (e.g., in the configuration mode), etc. In addition, via processor 52, computer 24 may be programmed to carry out any and/or all aspects of the processes of FIGS. 13-14, which are described below.

Memory 54 may include any non-transitory computer usable or readable medium, which may include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), as well as any other volatile or non-volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. As discussed above, memory 54 may store one or more computer program products which may be embodied as software, firmware, or the like.

In FIG. 1, a handheld mobile device 58 also is shown. In one example, the handheld mobile device 58 can serve as a proxy device—e.g., in lieu of receiving symbol primitives via the user interface 12. For example, computer 24 may include one or more components to facilitate wired and/or wireless communication with the handheld mobile device 58. For example, computer 24 may have a connector port (not shown) that is accessible within cabin 34 enabling a wired connection between computer 24 and mobile device 58. Or computer 24 may have one or more short range wireless communication chipsets to facilitate a wireless link (e.g., Bluetooth, Bluetooth Low Energy, Wi-Fi, etc.) between computer 24 and device 58. Non-limiting examples of mobile device 58 include a cellular telephone, a personal digital assistant (PDA), a Smart phone, a laptop or tablet computer having two-way communication capabilities (e.g., via a land and/or wireless connection), a netbook computer, and the like.

As described below, each of the powertrain control, climate control, and body control modules 28-32 may control one or more vehicle functions. Each module can comprise a computer having a processor (not shown) and memory (not shown) which is specially configured to carry out vehicle functions associated therewith. Further, in some examples, each module is representative of a system of interconnected computers or shared computing processes. Thus, the modules 28-32 are merely examples of how various computer-implemented processes can be carried out in vehicle 14. Thus, the exemplary vehicle functions which are associated with each respective module are merely examples as well; e.g., in other examples, the vehicle functions described below could be carried by a different module or different vehicle system. As will be discussed more below, in at least one example, one or more vehicle functions controlled by modules 28-32 may be carried out when the user draws a particular symbol primitive on the screen 36 of user interface 12.

In at least one example, the powertrain control module 28 carries out any suitable vehicle powertrain control functions. And upon receiving an instruction from computer 24—in response to the user drawing a symbol primitive on the user interface 12—module 28 may cause or actuate: a cruise control function (On, Off, Set, Coast, Resume, Accelerate, etc.), a drive mode (e.g., automatic or manual, or tailored modes such as Normal mode, Comfort mode, Sport mode, Economy mode, etc.), an ignition event (On, Off), a shift event (Park, Drive, Reverse, etc.), an engagement of an electronic parking brake, just to name a few examples. This list is not intended to be exhaustive, but merely exemplary. Thus, the powertrain control module 28 may execute and/or initiate other vehicle functions as well.

And in at least one example, the climate control module 30 carries out any suitable vehicle climate control functions. And upon receiving an instruction from computer 24—in response to the user drawing a symbol primitive on the user interface 12—module 30 may cause or actuate: movement and/or orientation of one or more vehicle cabin air vents, settings associated with heater(s) in one or more vehicle seats, settings associated with cooler(s) in one or more vehicle seats, cabin temperature and/or thermostat settings, just to name a few examples. Again, this list is not intended to be exhaustive, but merely exemplary. Thus, the climate control module 30 may execute and/or initiate other vehicle functions as well.

And in at least one example, the body control module 32 carries out any suitable vehicle body control or vehicle accessory functions. And upon receiving an instruction from computer 24—in response to the user drawing a symbol primitive on the user interface 12—module 32 may cause or actuate: an informational display of instrument panel cluster data, a status display (associated with vehicle or accessory charging data, a data link connection or the like), an infotainment system function (e.g., radio selection (AM, FM, XM, etc.), control of a media player, control of streaming media, application software execution or control, etc.), an operation setting associated with vehicle windshield wipers, a blaring of a vehicle horn, a locking or unlocking one or more vehicle power door locks, an opening or closing of vehicle power windows, a control of vehicle interior lighting (On, Off, Dim, etc.), a control of vehicle exterior lighting (running lights, trim or stylistic illumination, hazard indicator operation), a control of steering wheel tilt angle adjustment, a control of steering wheel telescopic adjustment, just to name a few examples. Again, this list is not intended to be exhaustive, but merely exemplary. Thus, the body control module 32 may execute and/or initiate other vehicle functions as well.

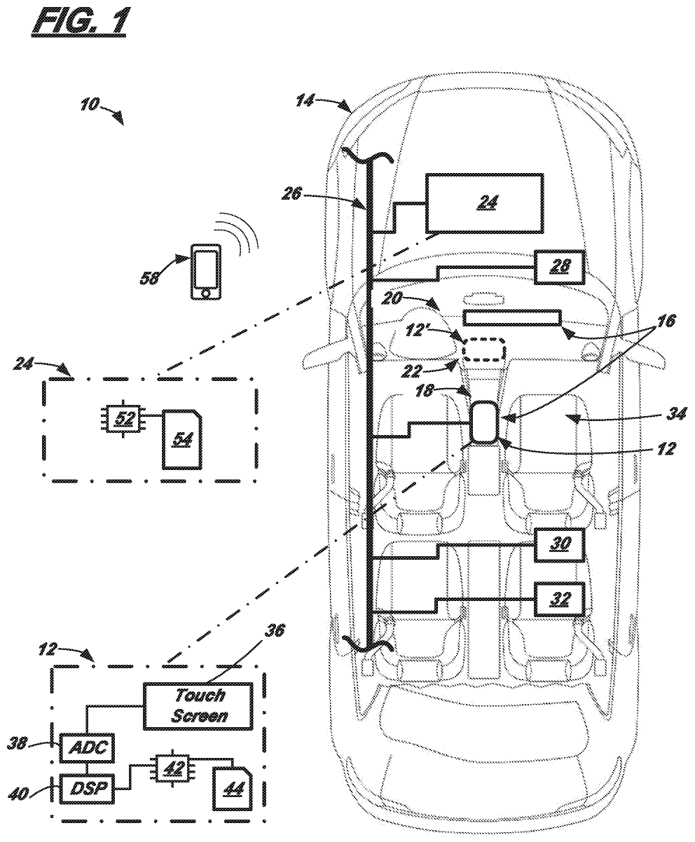

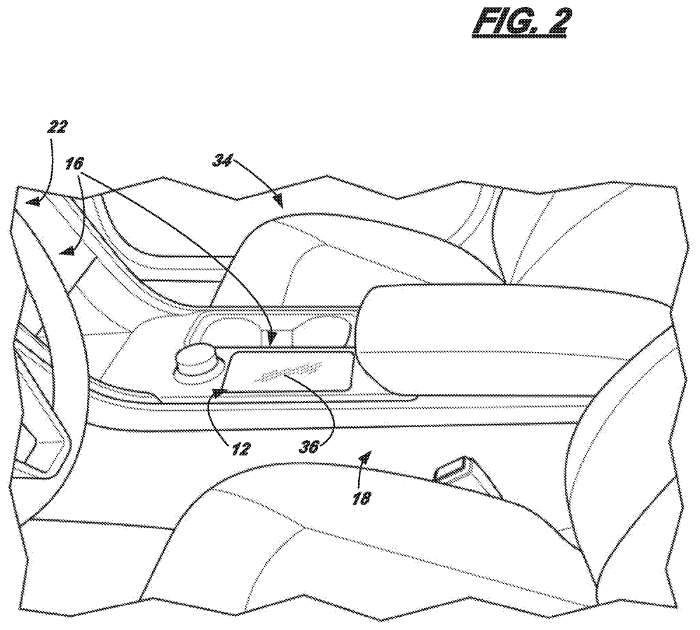

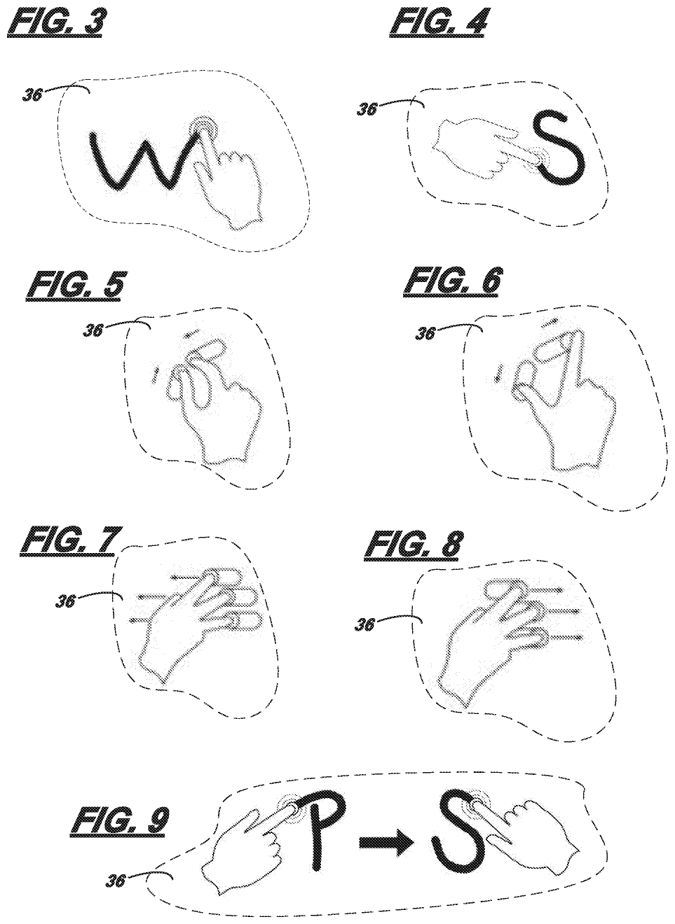

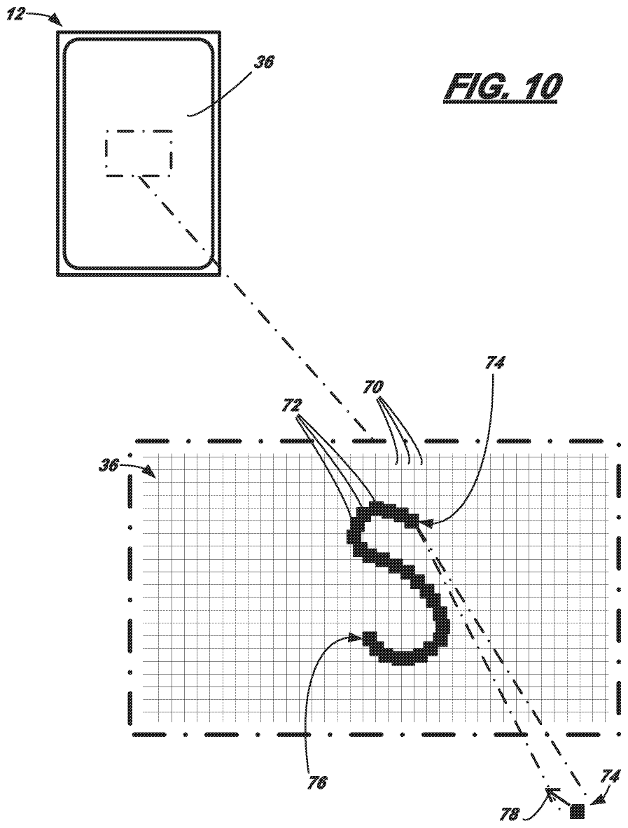

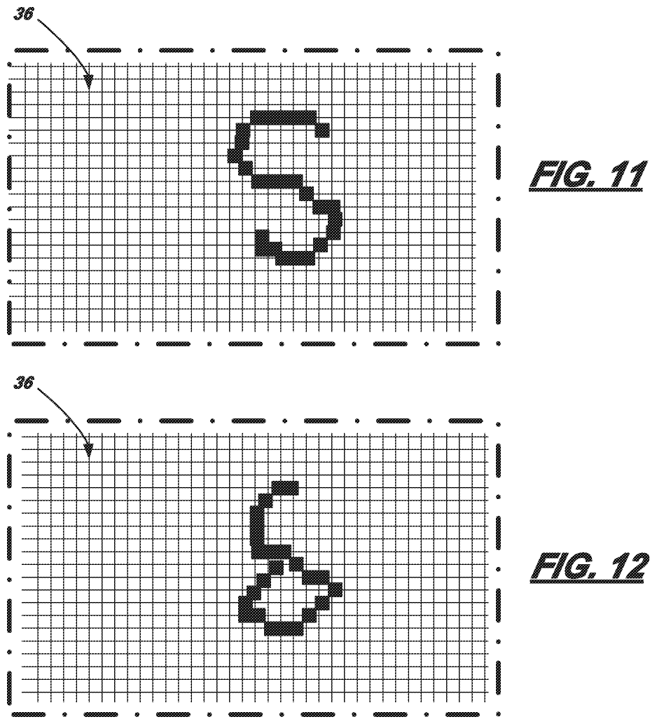

FIGS. 3-9 illustrate exemplary symbol primitives which a user may draw on user interface 12—e.g., using his/her finger, hand, etc. For example, in at least one implementation, the user's right forearm can rest on a portion of the floor console 18 thereby positioning the user's right hand to comfortably draw symbol primitives on the screen 36—e.g., without the user needing to remove the user's line of sight from the roadway ahead and/or around vehicle 14. Thus, symbol primitives may be provided to the computer 24 with minimal driver distraction. Of course, FIGS. 3-9 are not intended to be exhaustive or limiting, but merely to provide a few examples—e.g., as the quantity of potential symbol primitives is virtually limitless. More specifically, FIG. 3 illustrates a user finger contacting the screen 36 and drawing a “W”—the user could intend this symbol primitive to initiate a software application on a vehicle infotainment system (e.g., such as WhatsApp™). FIG. 4 illustrates a user finger contacting the screen 36 and drawing an “S”—the user could intend this symbol primitive to initiate another software application on the vehicle infotainment system (e.g., such as Spotify™). FIG. 5 illustrates a user thumb and index finger contacting the screen 36 and moving in a pinching motion—the user could intend this symbol primitive to decrease or lower cabin audio volume (e.g. from the vehicle infotainment system). FIG. 6 illustrates a user thumb and index finger contacting the screen 36 and moving in a spreading motion—the user could intend this symbol primitive to increase or raise cabin audio volume (e.g. from the vehicle infotainment system). FIG. 7 illustrates a user index, middle, and ring fingers contacting the screen 36 moving laterally (e.g., to the left)—the user could intend this symbol primitive to increase (or warm) cabin temperature. FIG. 8 illustrates a user index, middle, and ring fingers contacting the screen 36 moving laterally (e.g., to the right)—the user could intend this symbol primitive to decrease (or cool) cabin temperature. And FIG. 9 illustrates a user finger contacting the screen 36 and drawing a “P,” then drawing an “S”—the user could intend this symbol primitive to place a voice call to a specific person—e.g., dial a phone number (“P”) for Susan (“S”).

FIG. 10 illustrates the symbol primitive shown in FIG. 4 (e.g., the hand-drawn “S”) in greater detail. More specifically, screen 36 is shown divided into a number of un-contacted regions 70 (with respect to the current symbol primitive). At least some portions of the un-contacted regions 70 have been touched physically by the user's finger and are illustrated as contacted regions 72 (e.g., being darkened for illustration purposes—e.g., to distinguish locations on the screen 36 where physical contact between the user's finger and screen 36 has occurred). The size and quantity of regions 70, 72 are illustrative. Thus, the un-contacted and contacted regions 70, 72 may be used to identify a shape or form of the symbol primitive. Regions 70, 72 may form part of the tactile data set that defines the symbol primitive—e.g., which is sent from the user interface 12 to the computer 24 (described above). The data set further may be defined by one or more points of initial contact 74 and one or more points of terminal contact 76. In FIG. 10, the user-drawn “S” has only one point of initial contact 74 and one point of terminal contact 76; however, in other symbol primitive examples (e.g., such as those shown in FIGS. 5-9), more such initial and terminal contact points 74, 76 may exist. Still further, the data set may comprise one or more vectors 78—e.g., in FIG. 10, the initial contact point 74 is shown with an associated vector 78 having a direction relative to the next contacted region 72 as the user forms the letter “S.” In at least one example, each contacted region 72 may have an associated vector 78 indicating the direction of the next contacted region 72 (e.g., except the terminal contact 76). And yet still further, the data set may comprise at least one time interval associated with one or more portions of the symbol primitive—e.g., typically between 0.3 and 3 seconds (although this exemplary time range is not intended to be limiting). In at least one example, the time interval is measured from the first point of initial contact 74 to the last point of terminal contact 76—e.g., appreciating that some symbol primitives may have more than one contact 74, 76.

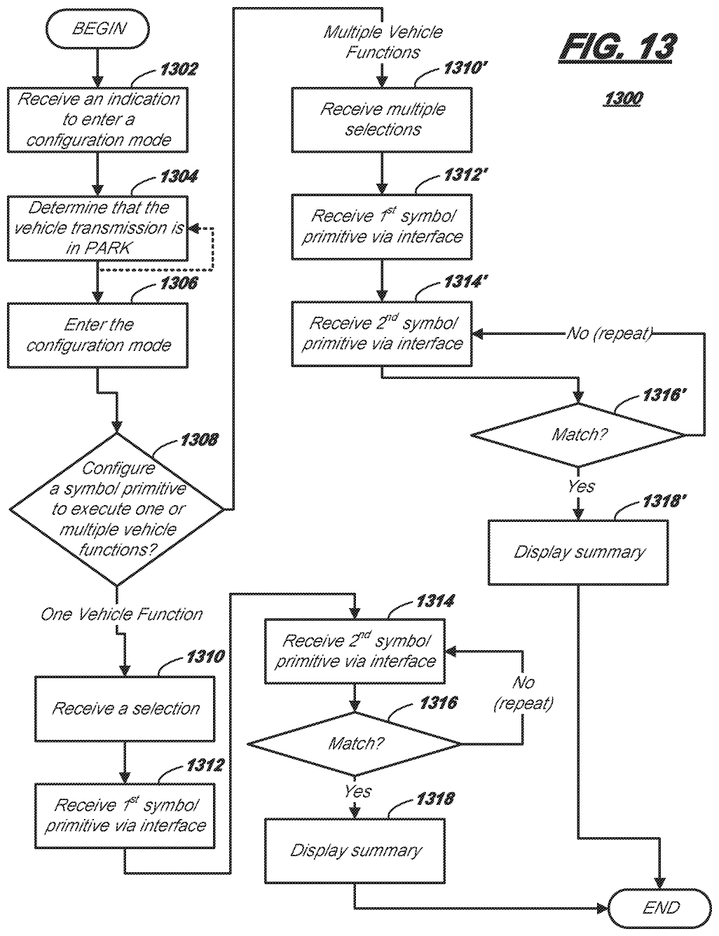

As will be described more below, the user repeatedly may use a particular symbol primitive to control operation of an associated vehicle function; however, the parameters of the data set may differ in some degree because the user is hand-drawing the symbol primitive on the screen 36. Computer 24 may be programmed to identify variations of the same desired symbol primitive. For example, FIG. 11 illustrates the symbol primitive of FIG. 10 having a data set with at least one of the following: a different point of initial contact 74, a different point of terminal contact 76, one or more different contacted regions 72, one or more different vectors 78, or a different time interval. For each symbol primitive stored in memory 54, computer 24 may be programmed to compare a number of differential values associated with one or more of the initial contact(s) 74, the terminal contact(s) 76, the contacted regions 72, the vectors 78, the time interval(s), and the like. If one or more differential values are larger than one or more respective predetermined thresholds, then computer 24 may not identify the hand-drawn symbol primitive. Similarly, in some examples, multiple differential values may need to exceed respective predetermined thresholds before computer 24 fails to identify the hand-drawn symbol primitive. Thus, computer 24 may utilize an objection identification algorithm to determine whether an inputted symbol primitive (e.g., on screen 36) matches a stored symbol primitive in memory 54. Such algorithms are known in the art; therefore, such a determination by computer 24 executing such an algorithm will not be explained here in greater detail. Thus, as used herein, determining a match at computer 24 requires a threshold level of tactile data set similarity (e.g., between the two data sets); consequently, it does not require all parameters of a currently inputted symbol primitive (data set) to be identical to all the parameters of a stored symbol primitive (data set).

As will be explained in the process illustrated in FIG. 13, in at least one implementation of a configuration mode, the vehicle user may draw a symbol primitive on screen 36 and associate the symbol primitive with the execution of a vehicle function. The computer 24 may be programmed to recognize inputted symbol primitives which may be confusingly similar with existing, stored symbol primitives. According to one non-limiting example, FIG. 12 illustrates symbol primitive inputted during the configuration mode which appears more like a “δ” (Greek delta symbol) than a letter “S.” Using the object identification algorithm discussed above, computer 24—having previously configured the “S” to trigger the execution of a first vehicle function—may reject a user-desired configuration of the Greek delta symbol for triggering an execution of a second (different) vehicle function. This is an example intended to illustrate that, using the algorithm and any suitable number of preconfigured recognition tolerances (also known in the art), computer 24 may inhibit the assignment of some symbol primitives to vehicle functions—e.g., based on a higher probability that when the user later inputs the symbol primitive while driving (and presumably not looking at the user interface 12 as he/she draws the symbol primitive), a false-positive identification by computer 24 may occur.

FIG. 13 illustrates a process 1300 of customizing the vehicle function control system 10 according to preferences of the vehicle user. Prior to process 1300, the user interface 12 may be operating in an operational mode—e.g., permitting a vehicle user to execute vehicle functions using the user interface 12, as will be explained more below. Alternatively, the user interface 12 may be powered OFF or in a sleep mode or the like.

The process begins with block 1302 wherein computer 24 receives an indication to enter a configuration mode. This indication may include any type of communication between the vehicle user and HMI 16. Non-limiting examples include computer 24 receiving an electrical signal in response to the user actuating touch screen 36 or any other switch, button, or the like on the user interface 12, the instrument panel 20, or the center stack module 22. In at least one example, the computer 24 receives an electrical signal from the user interface 12 as a result of the user making a menu selection via touch screen 36 (e.g., via a so-called ‘soft’ switch)—e.g., selecting a soft switch to enter the configuration mode. Thus, in at least one example, the process exits the operational mode and enters the configuration mode.

Upon receiving the indication to enter the configuration mode (block 1302), computer 24 may determine whether the transmission of vehicle 14 is in PARK (block 1304). If the vehicle transmission is not in PARK, computer 24 may not permit the process 1300 to proceed until it is. In one example, computer 24 receives a message or other indication from the powertrain control module 28. In this manner, the computer 24 may inhibit the user from attempting to drive vehicle 14 during the configuration mode—as the configuration mode requires more attention from the vehicle user than does the operational mode. For example, via screen 36, computer 24 may present an informational message to the vehicle user to park the vehicle 14. Until the transmission is in PARK, process 1300 may loop back and repeat block 1304—or in some examples, the configuration mode may terminate (e.g., returning to the operational mode).

When computer 24 determines that the vehicle is in PARK, computer 24 enters the configuration mode (block 1306). In at least one example, upon entering the configuration mode, the computer 24 displays via the user interface 12 a first selection menu—e.g., offering a choice to the user to assign a single vehicle function to a desired symbol primitive or to assign multiple vehicle functions to the desired symbol primitive (block 1308). Similarly, the user may be presented with two or more soft switch options. If the user chooses to assign one vehicle function to the symbol primitive, then process 300 proceeds to block 1310. However, if the user chooses to assign multiple vehicle functions to the symbol primitive, then the process proceeds instead to block 1310′.

In block 1310 (one vehicle function), computer 24 may present a second selection menu to the vehicle user via user interface 12. The second selection menu may offer a list number of vehicle functions. This list may be presented as a single listing, or the vehicle functions may be grouped according to categories, sub-menus, etc. This list may include one or more vehicle functions associated with the powertrain control module 28, the climate control module 30, the body control module 32, and/or any other suitable vehicle module, system, or sub-system. A number of non-limiting vehicle functions were described above; thus, a listing will not be reproduced here. Regardless of the presentation of the second selection menu, computer 24—via the user interface 12—may receive an indication of the desired vehicle function; for purposes of illustration only, the user could select a function for initiating the Spotify™ software application, discussed above. In at least one example, the indication received at computer 24 may be a unique identifier associated with initiating the Spotify™ software application.

Block 1310 may be carried out in other ways as well. For example, the user could actuate a desired vehicle function—e.g., selecting it via the HMI 16 or other vehicle user interface, and computer 24 could identify the desired vehicle function based on the actuation (e.g., an auto-detect mode). For example, continuing with the example above, in the configuration mode, the user could begin to initiate the Spotify™ software application, and computer 24 could detect this actuation (e.g., receiving a notification from the body control module 32). In some implementations, computer 24—via the user interface 12—could display a textual description or symbolic representation of the vehicle function to permit the vehicle user to verify the selection. And the user could confirm the selection by touching a soft switch on the user interface screen 36.

Next in block 1312, computer 24 may prompt—via the user interface 12—the vehicle user to enter the symbol primitive to be associated with the desired vehicle function. Accordingly, the user may establish physical contact with the screen 36 and draw the desired symbol primitive—e.g., with his or her hand and/or finger(s). Thus, computer 24—via the user interface 12—may receive an electrical output from interface 12 that comprises a symbol primitive (e.g., a tactile data set) that includes one or more of the following: a point of initial contact, a point of terminal contact, one or more contacted regions, one or more vectors, and at least one time interval. Computer 24 may associate this data set with the desired vehicle function set forth in block 1310—e.g., storing the data set and vehicle function in memory 54. Continuing with the example above, computer 24 may store the data set shown in part in FIG. 10 with the vehicle function to initiate the Spotify™ software application.

In at least some examples, in block 1314, computer 24 may repeat the instructions executed in block 1312—e.g., again prompting the user to input the previously entered symbol primitive in order to validate the symbol primitive (e.g., to ensure that the correct symbol primitive is being entered by the vehicle user).

In block 1316, computer 24 may determine whether the first inputted symbol primitive (block 1312) matches the second inputted symbol primitive (block 1314). As discussed above, in determining a match, computer 24 does not need to determine an identical correlation between the data set (represented by block 1312) and the data set (represented by block 1314). If computer 24 does not determine a match, then process 1300 may loop back and repeat block 1314. Or alternatively, the process could loop back and repeat blocks 1312, 1314, and 1316. However, if computer 24 determines a match, then process 1300 proceeds to block 1318.

In block 1318, computer 24—via the user interface 12—may provide informational data that includes a summary of the configuration. Continuing with the example above, computer 24—via the user interface 12—may present a description of the vehicle function and an illustration of the symbol primitive drawn by the user (e.g., reproducing the symbol primitive on the screen 36 using the data sets of block 1312, block 1314, or a blend of the two (e.g., using averaging, scaling, and/or other suitable techniques)). Thereafter, process 1300 may end—e.g., returning to the operational mode. Alternatively, the computer 24—via the user interface 12—could loop back and repeat block 1308 (additionally offering an option to end the configuration mode).

Returning to block 1310′, blocks 1310′, 1312′, 1314′, 1316′, and 1318′ may be carried out similarly, except that computer 24 may assign a symbol primitive to multiple vehicle functions. For example, in block 1310′, the user could select multiple vehicle functions from a menu. Or in this block, the user may actuate a number of different vehicle functions and the auto-detect mode described above may identify the desired vehicle functions.

Having identified the desired multiple vehicle functions, blocks 1312′-1316′ may be identical to blocks 1312-1316. Therefore, these blocks will not be re-described here.

And in block 1318′, computer 24 may present a summary of the configuration, similar to that described above-except that the summary includes a listing of multiple vehicle functions to be associated with the symbol primitive. Thereafter, process 1300 may end—e.g., returning to the operational mode. Alternatively, the computer 24—via the user interface 12—could loop back and repeat block 1308 (additionally offering an option to end the configuration mode).

Other examples of process 1300 also exist. According to another example of block 1310′, computer 24—via user interface 12—could present multiple vehicle function to the user via interface 12 in a step-by-step manner—during the configuration mode. At each step, the user could have the option of adjusting a setting, deciding to actuate a function, or the like—i.e., when the associated symbol primitive later is provided during the operational mode. Thereafter, a symbol primitive could be assigned to the selected vehicle functions, as described above (e.g., in blocks 1312′-1318′).

According to another configuration instance, in at least one example, one or more preconfigured symbol primitives may be stored in memory 54. And in blocks 1312 and 1312′, computer 24—via user interface 12—may present those preconfigured symbol primitives (which are not yet assigned) to the vehicle user so that the vehicle user may select a desired symbol primitive and thereby associate it with the desired vehicle function(s)—rather than create or generate a customized symbol primitive by tactilely drawing it on screen 36. Alternatively, or in addition thereto, as part of the configuration mode, computer 24 may prompt the user to draw and/or re-draw the predetermined and unassigned symbol primitive—e.g., essentially executing the substance of blocks 1314, 1314′ or the like.

In yet another configuration mode example, the user may attempt to program the actuation of a vehicle function to a symbol primitive that is confusingly similar to a previously selected, a previously created, or an otherwise previously customized symbol primitive. For example, continuing with the examples discussed above, the user may enter a symbol primitive (e.g., as in blocks 1312 or 1312′), and the computer 24 may identify that the entered symbol has a number of parameters in its respective tactile data set that are identical to and/or similar to a stored symbol primitive's tactile data set—e.g., within a threshold level of similarity. In response, computer 24 may instruct—e.g., via user interface 12—the user to provide a different symbol primitive.

Turning now to FIG. 14, a process 1400 of using the vehicle function control system 10 is shown. The process occurs during the operational mode of the user interface 12 and/or computer 24. For example, the process 1400 may begin with block 1410 wherein the computer 24 receives a symbol primitive in the form of a tactile data set via the user interface 12. When such data sets are received during the operational mode, computer 24 may be programmed to interpret such receipts as instructions or commands from the vehicle user to execute previously-configured vehicle function(s).

In response to receiving the data set (block 1410), computer 24 may identify a symbol primitive, from memory 54, that has been previously assigned to one or more vehicle functions in accordance with process 1300 (block 1420). More particularly, computer 24 may determine a match to the data set received in block 1410. Again, as discussed above, determining a match may not require determining identical parameters between the data set received in block 1410 and the data set previously stored in memory 54.

In response to determining the match (block 1420), computer 24 may trigger one or more vehicle function(s) (block 1430)—e.g., by providing an instruction to control the respective vehicle function(s). These vehicle function(s) may be those assigned to the symbol primitive in blocks 1312, 1312′ of process 1300. Further, this instruction may be sent from computer 24 via the connection 26 to a corresponding module such as one or more of modules 28-32 or the like so that the respective module may actuate the vehicle function(s). Thereafter, process 1400 may end.

In other examples of process 1400, the computer 24 may re-prompt the vehicle user to input the symbol primitive if the received tactile data set is not identified—e.g., if no match is determined. Or computer 24 could prompt the user to enter the configuration mode (described in process 1300) and assign a new customized symbol primitive to one or more vehicle functions.

Modern vehicles have an increasing number of user controls and increasingly complex user interfaces. This is particularly true as automotive vehicles increasingly make mobile device software applications and the like available via vehicle infotainment systems. Using user interface 12, a vehicle user may be able to control a number of vehicle functions at a single interface. Further, the user may input symbol primitives without turning to look at screen 36. This may enable users to actuate the desired vehicle function(s) while retaining their focus on roadway objects while operating vehicle 14—thereby improving the vehicle user experience.

In addition, by using the user interface 12, the user need not be distracted, embarrassed, etc. while waving his or her hands in the air to gesture a vehicle function command (as is required by some conventional vehicle systems). Similarly, the user interface 12 is not responsive to audible noise—e.g., conversation from other occupants of vehicle 14 will not affect symbolic primitive inputs in the manner in which such conversation can affect voice control commands in the vehicle 14.

Thus, there has been described a customizable vehicle function control system for a vehicle. The system includes a computer and a touch-sensitive user interface. Using the interface, the computer can assign vehicle functions to symbol primitives determined by the vehicle user. For example, the user may select preconfigured symbol primitives, or the user may create or generate customized symbol primitives by tactilely drawing on the user interface. Thereafter, the user may input the symbol primitive on the user interface to carry out a desired vehicle function.

In general, the computing systems and/or devices described may employ any of a number of computer operating systems, including, but by no means limited to, versions and/or varieties of the Ford SYNC® application, AppLink/Smart Device Link middleware, the Microsoft® Automotive operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The processor is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. The processor may be programmed to process sensor data. Processing the data may include processing the video feed or other data stream captured by the sensors to determine the roadway lane of a host vehicle and the presence of any target vehicles. As described below, the processor instructs vehicle components to actuate in accordance with the sensor data. The processor may be incorporated into a controller, e.g., an autonomous mode controller.

The memory (or data storage device) is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory may store data collected from sensors.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A computer, programmed to:
in a configuration mode associated with a touch-sensitive user interface in a vehicle:
receive, via the interface, a symbol primitive, and
receive an indication of at least one vehicle function to be associated therewith; and
in an operational mode:
receive, via the interface, tactile data,
identify the primitive using the tactile data, and
provide an instruction to perform the at least one vehicle function based on the identification.

2. The computer of claim 1, wherein the tactile data comprises at least one of: a plurality of contacted regions, an initial contact point, a terminal contact point, a vector associated with at least some of the plurality of contacted regions, or a time interval.

3. The computer of claim 2, wherein the identification further comprises comparing a tactile data set associated with the symbol primitive to the tactile data received during the operational mode.

4. The computer of claim 1, wherein a screen of the interface comprises a resistive-touch screen, a surface capacitive-touch screen, a projected capacitive-touch screen, a surface acoustic wave or SAW-touch screen, or an infrared-touch screen.

5. The computer of claim 1, wherein the primitive and the tactile data are each associated with a physical user contact and a user movement at a screen of the interface.

6. A computer, programmed to:
receive tactile data via a touch-sensitive user interface in a vehicle;
using the data, identify a previously-configured symbol primitive that is associated with controlling a vehicle function; and
provide an instruction to control the function based on the identification.

7. The computer of claim 6, wherein the data comprises at least one of: a plurality of contacted regions, an initial contact point, a terminal contact point, a vector associated with at least some of the plurality of contacted regions, or a time interval.

8. The computer of claim 6, wherein identifying further comprises comparing the tactile data with other tactile data previously associated with the primitive that is stored in computer memory.

9. The computer of claim 8, wherein the computer further is programmed to receive the other tactile data during a user-initiated configuration mode.

10. The computer of claim 6, wherein a screen of the interface comprises a resistive-touch screen, a surface capacitive-touch screen, a projected capacitive-touch screen, a surface acoustic wave or SAW-touch screen, or an infrared-touch screen.

11. The computer of claim 6, wherein the computer further is programmed to, prior to receiving the tactile data: receive a vehicle function control selection from a vehicle user; receive the primitive via the interface; and associate, in memory, the selection with the primitive.

12. The computer of claim 6, wherein the primitive and the data are each associated with contact of one or more vehicle user fingers relative to a touch-sensitive screen in the interface, movement of the one or more fingers relative to the screen, or both.

13. A method, comprising:
receiving tactile data via a touch-sensitive user interface in a vehicle;
using the data, identifying a previously-configured symbol primitive that is associated with controlling a vehicle function; and
providing an instruction to control the function based on the identification.

14. The method of claim 13, wherein the data comprises at least one of: a plurality of contacted regions, an initial contact point, a terminal contact point, a vector associated with at least some of the plurality of contacted regions, or a time interval.

15. The method of claim 13, wherein identifying further comprises comparing the tactile data with other tactile data previously associated with the primitive that is stored in computer memory.

16. The method of claim 15, further comprising receiving the other tactile data during a user-initiated configuration mode.

17. The method of claim 13, wherein a screen of the interface comprises a resistive-touch screen, a surface capacitive-touch screen, a projected capacitive-touch screen, a surface acoustic wave or SAW-touch screen, or an infrared-touch screen.

18. The method of claim 13, further comprising, prior to receiving the tactile data: receiving a vehicle function control selection from a vehicle user; receiving the primitive via the interface; and associating, in memory, the selection with the primitive.

19. The method of claim 13, wherein the primitive and the data are each associated with contact of one or more vehicle user fingers relative to a touch-sensitive screen in the interface, movement of the one or more fingers relative to the screen, or both.

20. The method of claim 13, wherein the tactile data includes a plurality of first parameters and the primitive includes a plurality of second parameters, wherein the identifying includes determining a threshold level of similarity between the pluralities of first and second parameters.
